(19) United States
(12) Patent Application Publication
(10) Pub. No.: US 2025/0237243 A1
(43) Pub. Date: Jul. 24, 2025

(54) CLAMP FOR COLLAPSIBLE SHELTER

(71) Applicant: INTERNATIONAL E-Z UP, INC., Norco, CA (US)

(72) Inventors: Scott LEHMAN, Fontana, CA (US); Johnny MENDEZ, Palm Springs, CA (US)

(21) Appl. No.: 19/025,114

(22) Filed: Jan. 16, 2025

Related U.S. Application Data
(60) Provisional application No. 63/622,463, filed on Jan. 18, 2024.

(51) Int. Cl. F16B 2/06; E04H 15/50

(52) U.S. Cl. CPC F16B 2/06; E04H 15/50

(57) ABSTRACT

A clamp includes a body integrated with a second clamp arm and a first clamp arm pivotally attached to the body. The first clamp arm is configured to rotate outward and inward relative to the body. Additionally, the first clamp arm is parallel with the second clamp arm. Furthermore, a portion of the body and a portion of the first clamp arm form a hollow section to contain a structural element.

### CROSS-REFERENCE TO RELATED APPLICATION

The present application claims the benefit of U.S. Provisional Patent Application No. 63/622,463 filed on Jan. 18, 2024, and titled “CLAMP FOR COLLAPSIBLE SHELTER,” the disclosure of which is expressly incorporated by reference in its entirety.

### BACKGROUND

### Field

Certain aspects of the present disclosure generally relate to clamps for collapsible structures.

### Background

Portable shelters are widely used for various applications, including recreational, commercial, and professional purposes. These shelters are often collapsible, making them easy to transport and assemble at temporary locations. Examples of such shelters include camping tents, screened rooms, market booths, and specialized structures used for activities such as, but not limited to, crime scene investigations, medical treatments, or the creation of clean areas. The versatility and portability of these shelters have made them indispensable across a range of industries and activities.

To improve the functionality of portable shelters, it is often desirable to attach accessories or structural enhancements to their framework. For example, flags, banners, lighting, or fabric skirts can be mounted on the legs of the shelter to provide branding, improve aesthetics, or increase utility. Similarly, devices such as fans, televisions, or other equipment may need to be securely attached for specialized applications.

### SUMMARY

In some aspects, clamp includes a body integrated with a second arm and a first arm pivotally attached to the body. The first arm is configured to rotate outward and inward relative to the body. Additionally, the first arm is parallel with the second arm. Furthermore, a portion of the body and a portion of the first arm form a hollow section to contain a structural element.

In some aspects, a method of securing a structural element using a clamp includes rotating a first arm of the clamp outward from a body of the clamp to open a hollow section. The first arm may be pivotally coupled to the body, the body integrated with a second arm that extends outward from the body, additionally the second arm is parallel to the first arm. The method also includes positioning the structural element within the hollow section. The method further includes rotating the first arm inward to enclose the structural element securely within the hollow section.

Aspects generally include a method and an apparatus as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIGS. 1A and 1B illustrate examples of shelters with various structures attached to the frames.

FIG. 2 is an example of a conventional clamp.

FIG. 3 is an example of a conventional clamp attached to a leg of a shelter.

FIGS. 4A and 4B illustrate examples of elements of a multi-point fixed attachment system, according to various aspects of the present disclosure.

FIGS. 5, 6, and 7 illustrate examples of collapsible frames, according to various aspects of the present disclosure.

FIGS. 8A, 8B, 8C, 8D, 8E, 8F, 8G, 8H, 8I, 8J, 8K, 8L, 8M, 8N, 8O, 8P, 8Q, and 8R are diagrams illustrating examples of different views of a clamp, in accordance with various aspects of the present disclosure.

FIGS. 9A, 9B, 9C, 9D, 9E, 9F, 9G, 9H, 9I, 9J, 9K, 9L, 9M, 9N, 9O, 9P, 9Q, and 9R are diagrams illustrating examples of different views of a clamp, in accordance with various aspects of the present disclosure.

FIGS. 9S, 9T, and 9U are diagrams illustrating an example of an insert for a clamp, in accordance with various aspects of the present disclosure.

FIGS. 10A, 10B, 10C, and 10D are diagrams illustrating examples of different views of a bracket, in accordance with various aspects of the present disclosure.

FIGS. 11A, 11B, 11C, and 11D are diagrams diagram illustrating different views of an example of a truss-link clamp, in accordance with various aspects of the present disclosure.

FIG. 12 is a flow diagram illustrating an example of a process for using a clamp, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As discussed, to improve the functionality of portable shelters, it may be desirable to attach accessories or structural enhancements to their framework. For example, flags, banners, lighting, or fabric skirts can be mounted on the legs of the shelter to provide branding, improve aesthetics, or increase utility. Similarly, devices such as fans, televisions, or other equipment may need to be securely attached for specialized applications. However, securely attaching such items remains a significant challenge.

Conventional clamps used for attaching accessories to shelter frames often suffer from limitations. These clamps typically rely on tension or notched sections of the shelter legs to prevent slipping. Consequently, their load-bearing capacity is restricted, and they can only be attached to specific sections of the leg. Moreover, many existing clamps are constructed as rigid, single-piece designs that require significant force to install. This creates stress on the clamp material, increasing the likelihood of breakage and reducing long-term reliability.

Furthermore, traditional attachment systems often lack the versatility to accommodate legs of varying shapes and sizes, such as square, octagonal, or telescoping legs. These traditional attachment systems may also fail to provide adequate friction or support, leading to instability when heavier objects are mounted. These deficiencies can result in sagging, shifting, or detachment of accessories, compromising the overall functionality and safety of the shelter.

Accordingly, there exists a need for an improved clamping system that addresses the challenges of securely, flexibly, and durably attaching objects to the framework of portable shelters. Various aspects of the present disclosure are directed to a clamp that may be attached to any portion of a leg of a portable shelter. In some examples, the claim may be attached to a portion of the leg regardless of its size. Additionally, some clamps may be specified for square-shaped legs, while others may be specified for octagon-shaped legs. For example, the clamp may feature a square-shaped or octagon-shaped opening that is slidable along the leg of the portable shelter. Of course, other shapes are contemplated for the clamps. The clamp may be compatible with various shelter configurations, ensuring adaptability across diverse applications.

In some examples, the clamp may incorporate an insert to reduce the effective internal area of the clamp, enabling it to securely grip smaller-sized legs. To improve stability, padding may be included on one or more inner surfaces of the clamp, increasing friction between the clamp and the leg enabling the clamp to support a wide range of accessories, including banners, flags, lighting, or electronic devices. These padded sections may be indented to securely house the padding, which can be configured as individual pieces. This padding, also referred to as a rubber insert or simply an insert, may be made of rubber or other friction-enhancing materials.

In some examples, the clamp may function as a 90° or 180° bracket, wherein additional clamp arms are oriented at 90° or 180° relative to existing clamp arms. A portion of the clamp may be designed to pivot open at a hinge point, facilitating the wrapping of the clamp around a leg or similar structure before being securely fastened.

Additionally, or alternatively, in some examples, a bracket may be positioned between the clamp's two arms (e.g., prods). This bracket can serve as a mounting interface for additional hardware, such as a swivel mount for a TV or a fan. The bracket may include a vertically oriented hole for attaching such hardware, as well as one or more angled holes for securing poles or other objects at inclined positions. This design enhances the utility of the clamp by supporting multiple configurations and accessories.

Particular aspects of the present disclosure are directed toward achieving several potential advantages. These include improving the versatility and stability of clamps used on portable shelter legs, thereby enabling the secure and reliable attachment of a variety of objects and equipment. Such improvements enhance the overall functionality and user experience of portable shelters.

Additionally, the disclosed clamp design is not limited to attachment points on shelter legs. In some embodiments, the clamp may be adapted to attach to other structural components of a portable shelter, such as truss links or similar framework elements. This adaptability further broadens the scope of applications for the clamp system, making it suitable for a wider range of structural configurations.

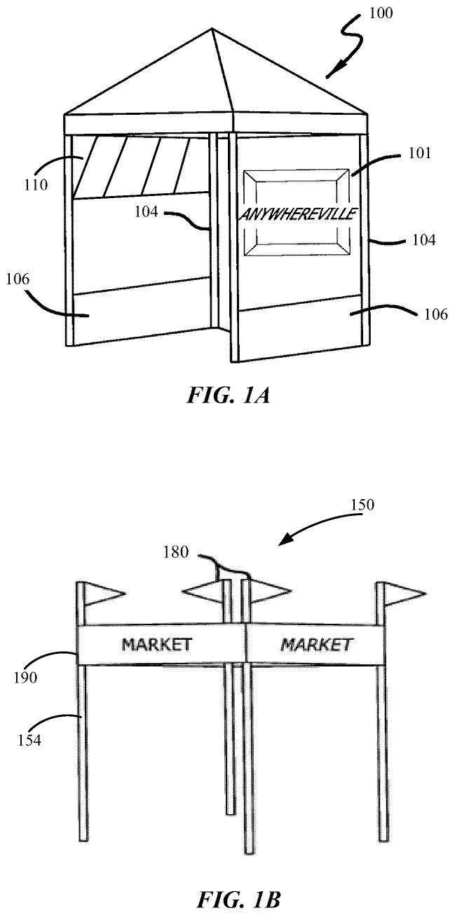

FIG. 1A illustrates an example of a conventional shelter 100 with sidewalls 101 and side skirts 106 attached to the legs 104. The sidewalls 101 and side skirts 106 may be formed of a fabric material such as polyester fabric. As previously discussed, in conventional systems, the sidewalls 101 and side skirts 106 may attach directly to the legs 104 or perimeter truss via a connection, such as a fastener attached to a strap. The connections are neither secure nor taut. Therefore, the sidewalls 101 and side skirts 106 are prone to sagging or disconnecting from the legs 104. Additionally, or alternatively, banners, flags, and/or other types of dressings may be mounted to the legs and/or frame. As an example, half walls 110 may also be mounted to the legs 104. FIG. 1B illustrates another example of a booth structure 150 with flags 180 and banners 190 may be mounted to the legs 154.

As shown in FIGS. 1A and 1B, the sidewalls 101, side skirts 106, flags 180, and banners 190 are visible from the exterior of the shelter 100. The sidewalls 101, side skirts 106, flags 180, and banners 190 may have information printed on both sides. Still, there is unused space on the interior of a shelter's dome (e.g., ceiling). Still, the space on the interior of the shelter's dome may also be used to provide information (e.g., advertisements). Conventional fastening systems do not provide a system for attaching structures, such as flags and banners to an interior of the shelter.

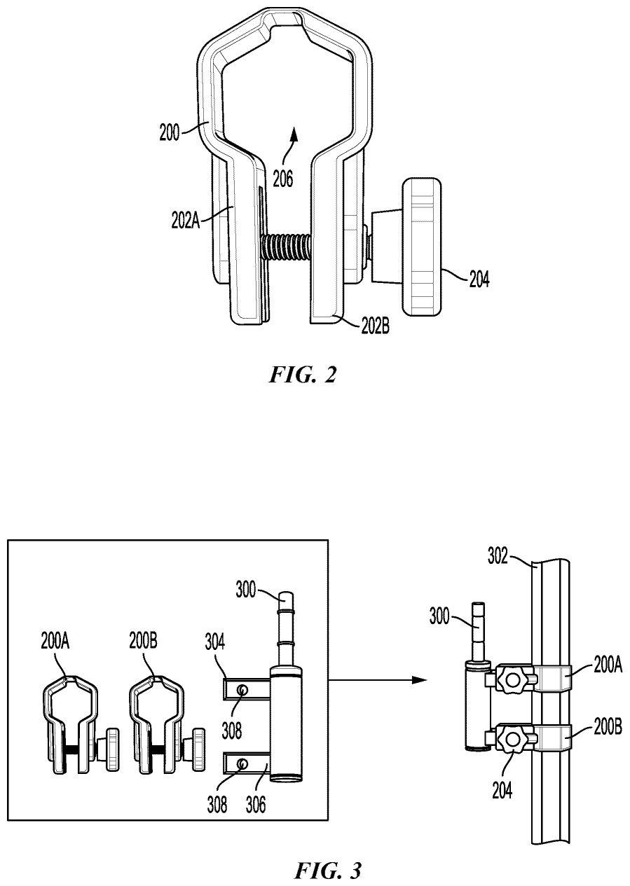

FIG. 2 is an example of a conventional clamp 200. The clamp 200 may include two arms 202A and 202B, an opening 206 for receiving a leg of a shelter, and a screw 206 for securing an object between the two arms 202A and 202B. As shown in the example of FIG. 2, a single piece of material is molded to form a body of the clamp 200. Accordingly, to fit the clamp 200 around a leg, a user may pull the arms 202A and 202B outward, such that the leg is received in the opening 206. This causes stress to the body and may cause the arms 202A and 202B or other portions of the clamp to break. Additionally, the clamp 200 is secured to the leg based on the tension between the body of the clamp 200 and the leg; the tension results from tightening the screw. As such, the clamp 200 may be limited in an amount of weight it can bear.

FIG. 3 is an example of a conventional clamp attached to a leg 302 of a shelter. In the example of FIG. 3, two clamps 200A and 200B may be attached to the leg 302. Each clamp 200A and 200B is an example of a clamp 200 described with reference to FIG. 2. In the example of FIG. 3, a flag pole 300 may be attached to each clamp 200A and 200B. Specifically, the flag pole 300 may include two mounting arms 304 and 306, each having a respective hole 308 for receiving a screw 204. For example, the screw 204 of a first clamp 200A may pass through the hole 208 of the first mounting arm 304 to secure the first mounting arm 304 to the first clamp 200A. A similar process may be used to secure the second mounting arm 306 to the second clam 200B.

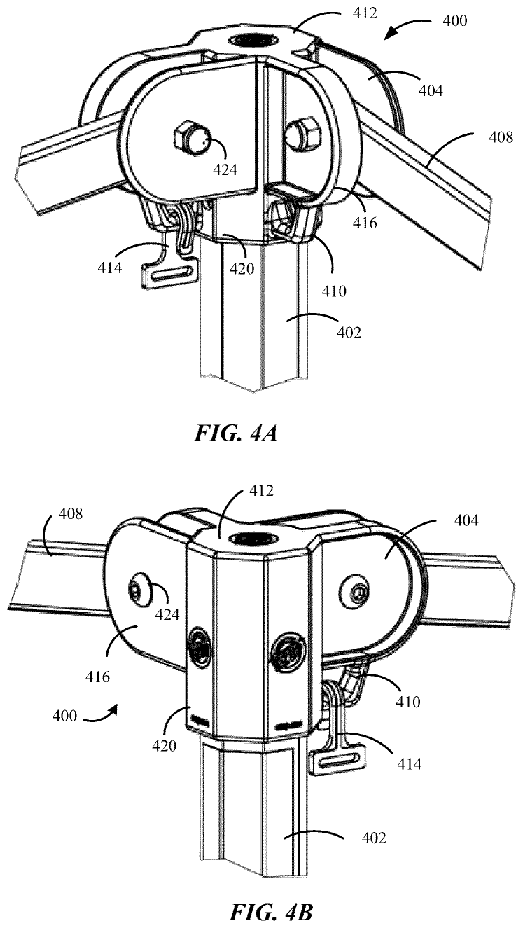

In some examples, each leg may be connected to a leg bracket. FIGS. 4A and 4B illustrate examples of different views of a leg bracket 400 in accordance with various aspects of the present disclosure. FIG. 4A illustrates a first view (e.g., front view) of the leg bracket 400 and FIG. 4B illustrates a second view (e.g., back view) of the leg bracket 400. The second view is opposite of the first view. As shown in FIGS. 4A and 4B, the leg bracket 400 is connected to a leg 402 of the collapsible frame. That is, a socket 420 of the leg bracket 400 receives an end of the leg 402. The leg 402 may be attached to the socket 420 via a bolt or other attachment (not shown).

The leg bracket 400 includes multiple sockets 404 extending outward from a body 412 of the leg bracket 400. Each socket 404 may be at substantially right angle from an adjacent socket 404. Aspects of the present disclosure are not limited to two sockets 404 as shown in FIGS. 4A and 4B; the leg bracket 400 may have one or more sockets 404. For example, in one configuration, the leg bracket 400 includes only one socket 404 extending outward from a body 412 of the leg bracket 400.

An end of a link member 408 is received in each socket 404 of the leg bracket 400. The end of the link member 408 may be pivotally connected to the socket 404. Specifically, the end of the link member 408 may be attached to the socket via a bolt 424 or other attachment. The socket 404 of the leg bracket 400 includes two arms 416. As a roof and a floor are not defined for each socket 404 of the leg bracket 400, the link member 408 may pivot in an up or down direction.

In one configuration, a handle 410 (e.g., attachment point) is defined below each socket 404. A first end of the handle 410 may be attached to a bottom of one arm 416 of the socket 404 and a second end of the handle 410 may be attached to the body 412 of the leg bracket 400. Each handle 410 may be adaptable to receive a fastener 414. As previously discussed, the fastener 414 is adapted to be connected to material of a structure via a strap or other type of connector. The leg bracket 400 is not limited to receiving link members and may receive telescoping pole members, flexible rods, or other structures of a frame of a shelter. Additionally, or alternatively, each bracket 400 may include additional sockets. For example, each bracket may include three sockets, wherein a third socket pivotally receives an inner truss link.

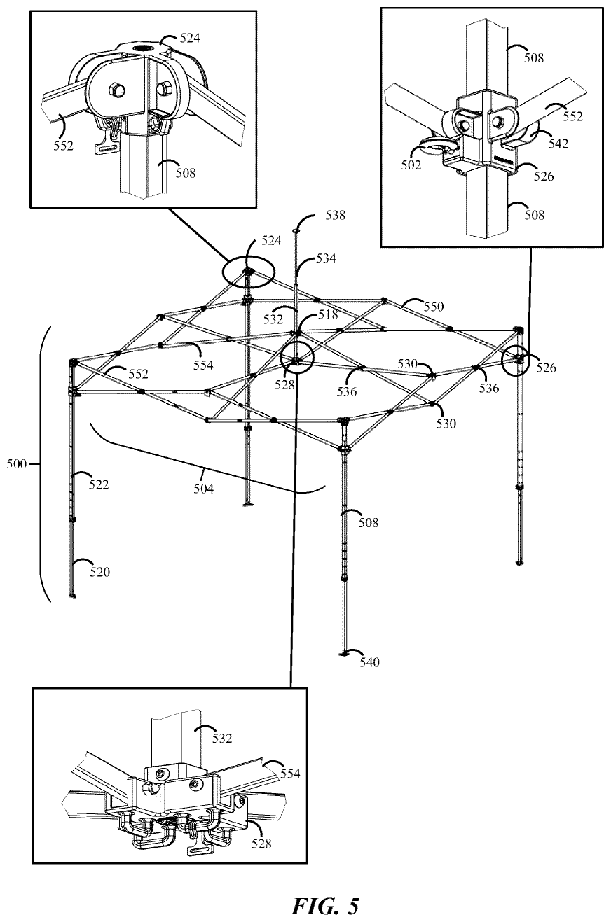

FIG. 5 illustrates an example of a frame of a shelter 500. The shelter 500 may be a modular folding shelter, such as a display booth. As shown in FIG. 5, the frame has four sides 504 and four corners. Each side 504 may be substantially perpendicular to one or more adjacent sides 504. Of course, aspects of the present disclosure are not limited to a frame with four sides and four corners, as other configurations, such as three sides and three corners, are also contemplated. Additionally, adjacent sides 504 may be connected at an angle that is greater than or less than 90 degrees. The frame may be collapsible. In another configuration, the frame is fixed.

In one configuration, legs 508 are provided at each corner to erect the frame. Each leg 508 may be an example of a leg 300 described with reference to FIG. 3. The legs 508 may be telescoping (e.g., extendable). That is, each leg 508 may comprise a telescoping lower section 520 that extends from a hollow upper section 522. The telescoping lower section 520 may be slidably disposed within the hollow upper section 522. Each telescoping lower section 520 has a foot 540 for engagement with the ground. Additionally, a perimeter truss frame 550 is connected to the legs 508 via brackets 524, 526 to stabilize and support the frame of the shelter 500. The perimeter truss frame 550 may also be referred to as a perimeter truss framework.

The perimeter truss frame 550 may include multiple outer truss links 552 and multiple inner truss links 554. Two outer truss links 552 may form an outer truss link pair. The outer truss links 552 of each outer truss link pair may be pivotally connected to each other at a cross-link joint 536, such as in a scissor configuration. In one configuration, a first end of each outer truss link 552 is pivotally connected to a leg 508 via either a leg bracket 524 or a sliding bracket 526. That is, a first end of one outer truss link 552 of each outer truss link pair may be pivotally connected to a socket of the leg bracket 524. Each socket of the leg bracket 524 may include an attachment point (e.g., handle) for receiving a fastener (see FIGS. 4A-B). The first end of another outer truss link 552 of each outer truss link pair may be pivotally connected to a socket of a sliding bracket 526, such that one outer truss link 552 of an outer truss link pair is slidably connected to a corresponding leg 508. A second end of each outer truss link 552 may be connected to a second end of another outer truss link 552 at an outer joint 530. The outer joint 530 may be a three-way joint.

As shown in FIG. 5, two inner truss links 554 may be pivotally connected at a cross-link joint 536 to form an inner truss link pair. Two inner truss links 554 may be pivotally connected, such as in the scissor configuration. In one configuration, a first end of a first inner truss link 554 is pivotally connected to a second end of two outer truss links 552 at an outer joint 530. A second end of the first inner truss link 554 of each inner truss link pair is pivotally connected to a peak slider 518. Furthermore, a first end of a second inner truss link 554 of each inner truss link pair is pivotally connected to a second end of two outer truss links 552 at an outer joint 530. A second end of the second inner truss link 554 of each inner truss link pair is pivotally connected to a socket of the center bracket 528. Each socket of the center bracket 528 may include an attachment point (e.g., handle) for receiving a fastener (see FIG. 2).

The shelter 500 may include a peak beam 532 for supporting a roof structure (not shown), such as a canopy. The peak beam 532 may be attached to a center bracket 528. The peak slider 518 may also be slidably attached to the peak beam 532. In one configuration, a peak pole 534 is telescoping (e.g., extendable) from the peak beam 532. That is, the peak beam 532 may be hollow so that the peak pole 534 may extend upward from the peak beam 532. The peak pole 534 may be slidably disposed within the peak beam 532. Additionally, the peak pole 534 may include a top bracket 538 for engaging a roof structure, such as a canopy.

The top bracket 538 may also include attachment points. In one configuration, a sail banner may be attached to an attachment point of the top bracket 538 and an attachment point on one or more leg brackets 524. Additionally, or alternatively, the sail banner may be attached to other components of the shelter. The sail banner may be used to display information on the interior of the shelter 500. In one configuration, a roof material may be placed on the shelter 500. In this configuration, the roof structure is placed over the sail banner, such that only the roof structure is visible from the exterior of the shelter 500, while both the roof structure and the sail banner are visible from the interior of the shelter 500.

FIG. 5 illustrates an example of a sliding bracket 526 according to aspects of the present disclosure. As shown in FIG. 5, a leg 508 passes through an opening of the sliding bracket 526. A pin 502 is used to engage the sliding bracket 526 with an opening in the leg 508 to keep the sliding bracket 526 in a desired position. The sliding bracket 526 includes one or more sockets 542 for engaging an end of a truss link, such as an outer truss link 552. A truss link may pivot within the socket 542. In one configuration, the sliding bracket 526 includes one or more attachment points of the multi-point attachment system.

Aspects of the present disclosure are not limited to the frame of the shelter 500, other frame types are contemplated. The frame of the shelter 500 shown in the example of FIG. 5 does not include flexible rods. Therefore, this frame may struggle with maintaining structural stability in diverse environments. It may be desirable to add flexible rods to the frame of the shelter 500.

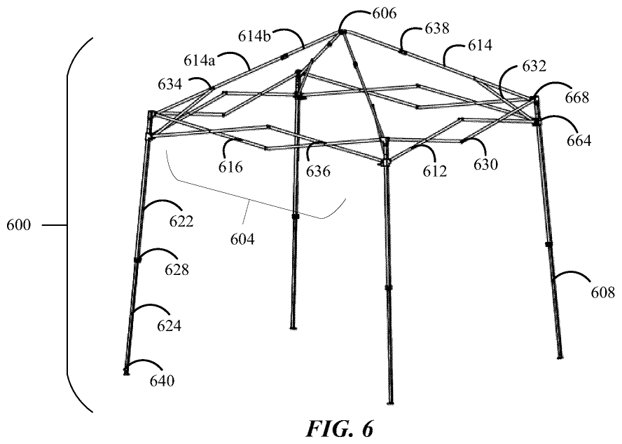

FIG. 6 illustrates an example of a frame for a shelter 600 with a peak-shaped roof in accordance with aspects of the present disclosure. The shelter 600 may be a modular folding shelter, such as a display booth. As shown in FIG. 6, the shelter 600 has four sides 604 and four corners. Each side 604 may be substantially perpendicular to one or more adjacent sides 604. Of course, aspects of the present disclosure are not limited to a shelter 600 with four sides and four corners, as other configurations are also contemplated. The shelter 600 may be collapsible. The shelter 600 shown in the example of FIG. 6 does not include flexible rods. Therefore, this shelter 600 may struggle with maintaining structural stability in diverse environments. It may be desirable to add flexible rods to the shelter 600.

In one configuration, legs 608 are provided at each corner to erect the shelter 600. The legs 608 may be telescoping (e.g., extendable). That is, each leg 608 may comprise a telescoping lower section 624 that extends from a hollow upper section 622. The telescoping lower section 624 may be slidably disposed within the hollow upper section 622. A slider 628, such as a slider with a pull pin, may be used to extend the telescoping lower section 624 from the hollow upper section 622. Each telescoping lower section 624 has a foot 640 for engagement with the ground. Additionally, a perimeter truss frame 616 is connected to the legs 608 for stability and support.

The perimeter truss frame 616 may include multiple outer truss links 612. Two pivotally connected outer truss links 612 may form an outer truss link pair. The outer truss links 612 of each outer truss link pair may be pivotally connected to each other at a cross-link joint 636, such as in a scissor configuration. In one configuration, a first end of each outer truss link 612 is pivotally connected to a leg 608 via a sliding bracket 664 or a leg bracket 668. Specifically, the first end of one outer truss link 612 of each outer truss link pair may be pivotally connected to a socket of a sliding bracket 664. The first end of another outer truss link 612 of each outer truss link pair may be pivotally connected to a socket of the leg bracket 668, such that each outer truss link 612 is pivotally connected to a corresponding leg 608. The leg bracket 668 and/or the sliding bracket 664 may include one or more attachment points (see FIGS. 4A-B). A second end of each outer truss link 612 may be connected to a second end of another outer truss link 612 at an outer joint 630.

As shown in FIG. 6, the frame may include multiple upper peak truss links 614 and lower peak truss links 632. A first end of each upper peak truss link 614 may be pivotally connected to a leg bracket 668. A second end of each upper peak truss link 614 may be pivotally connected to a peak center bracket 606. The center bracket 606 may include one or more attachment points of the multi-point attachment system. Each upper peak truss link 614 may also include a peak joint 638, such that a first portion 614a and a second portion 614b of each first peak truss link 614 are foldable. A first end of a lower peak truss link 632 may be pivotally connected to the upper peak truss link 614 at a truss joint 634. A second end of the lower peak truss link 632 may be pivotally connected to socket of a sliding bracket 664. Each socket of a sliding bracket 664 may include a handler for receiving a fastener.

The lower peak truss links 632 may provide support to a corresponding (e.g., adjacent) upper peak truss link 614. The upper peak truss links 614 form a peak for supporting a roof structure (not shown), such as a canopy. The lower peak truss links 632 and/or upper peak truss links 614 may be made of a rigid material or flexible material. The truss links may form a dome shape roof, a pyramid shape roof, or other type of roof.

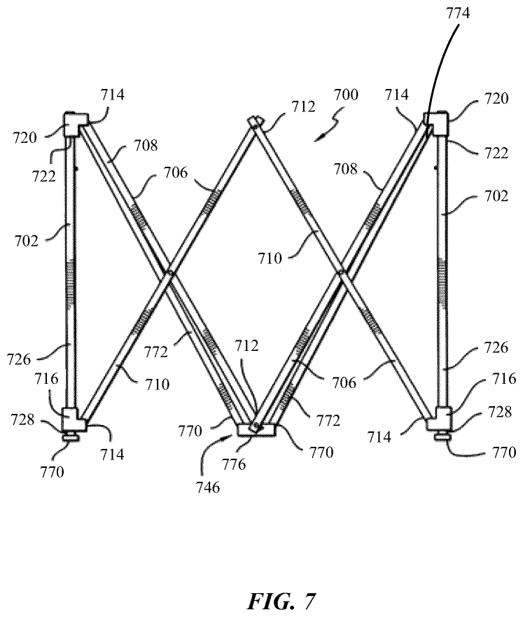

FIG. 7 illustrates an example of a shelter in a partially collapsed position. As shown in FIG. 7, a perimeter truss link assembly 700 having multiple perimeter truss pairs of link members 706 is connected to each leg 702. Each of the perimeter truss pairs including first link members 708 and second link members 710 that are pivotally connected together, such as in a scissor configuration. The first link member 708 and second link members 710 have inner ends 712 and outer ends 714. The outer end 714 of each first link member 708 connected to the upper end of one leg 702 via a leg bracket 720, and the outer end 714 of each second link member 710 being connected to a sliding leg bracket member 716 so as to be slidably connected to the leg 702. The inner ends 712 may be pivotally connected to each other. Each leg 702 may comprise a hollow upper section 726 and a telescoping lower section 728, with the lower section slidably disposed within the upper section, with the lower section having a foot section 770 for engagement with the ground. An end 722 of each leg 702 is connected to the leg bracket 720.

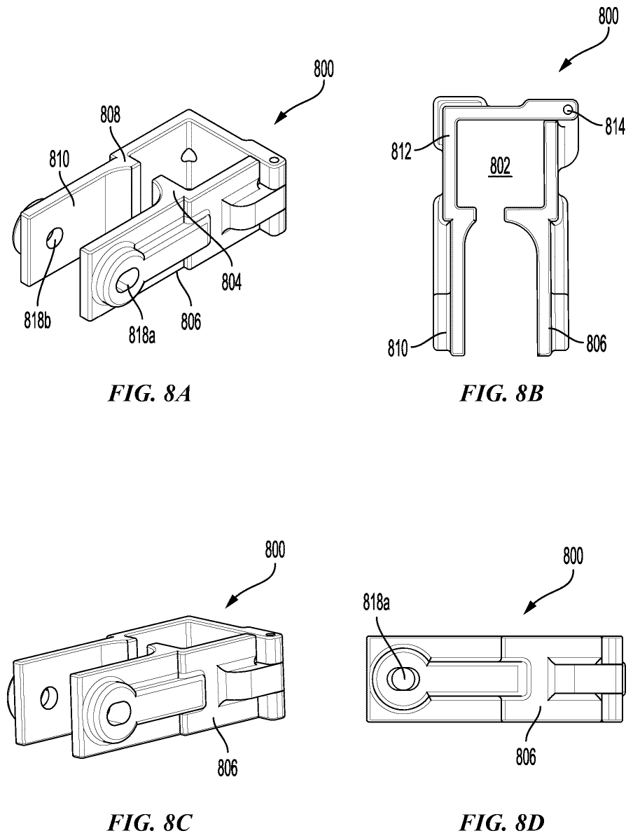

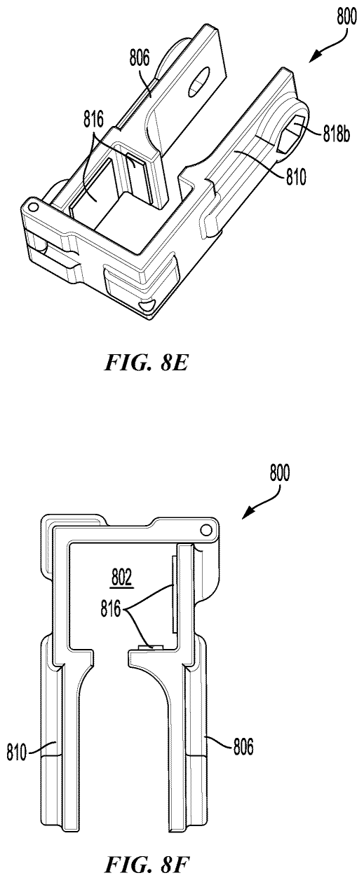

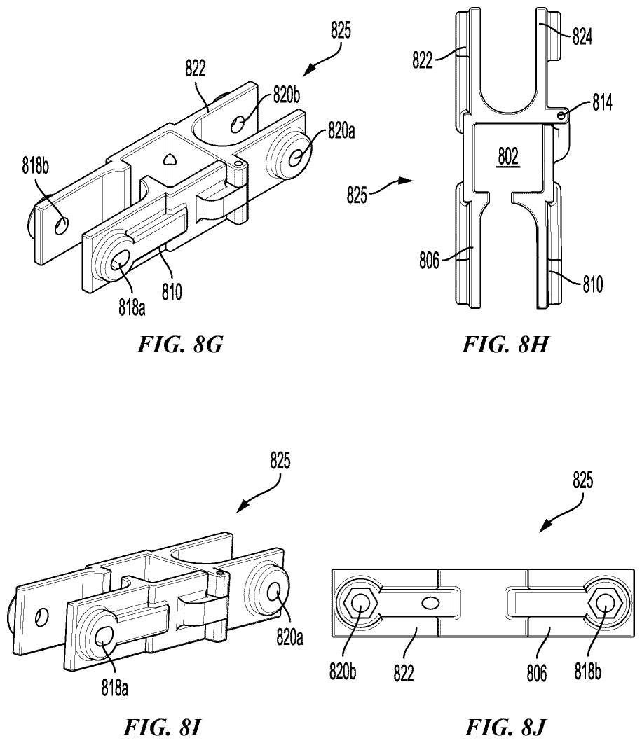

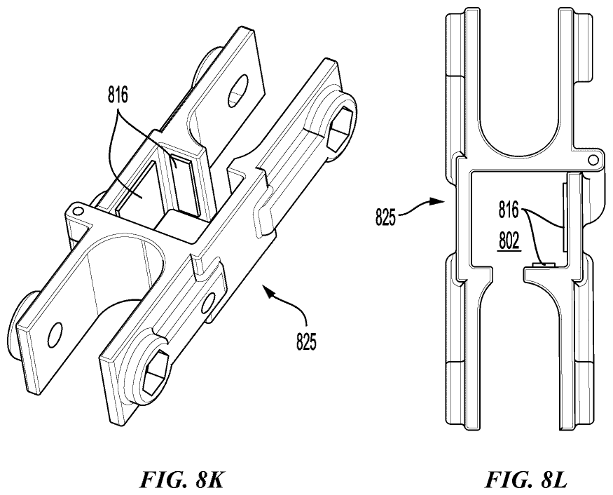

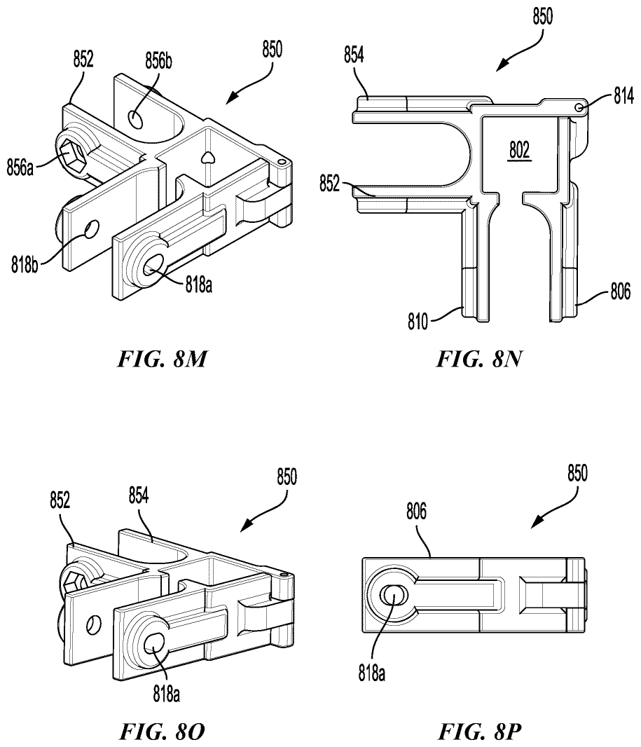

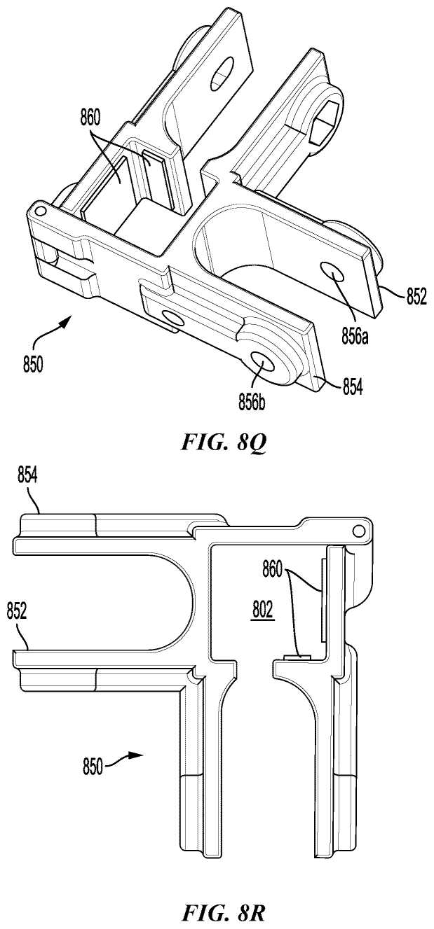

FIGS. 8A, 8B, 8C, 8D, 8E, and 8F are diagrams illustrating examples of different views of a clamp 800, in accordance with various aspects of the present disclosure. For brevity, the numbering of some elements is not repeated throughout FIGS. 8A, 8B, 8C, 8D, 8E, and 8F. The clamp 800 is an example of a square-shaped clamp that is coupled to a square-shaped leg. The square-shaped leg may be an example of the leg 522 described with reference to FIG. 5. The leg may be secured between three walls, with a first protrusion 804 that extends perpendicularly from a first clamp arm 806 and a second protrusion 808 that extends perpendicularly to the second clamp arm 810. A space exists between the first protrusion and the second protrusion. The clamp 800 may be attached to various portions of the leg, such as a hollow upper section of the leg. The hollow upper section may be an example of the hollow upper section 522 described with reference to FIG. 5.

As shown in the examples of FIGS. 8A, 8B, 8C, 8D, 8E, and 8F, the clamp 800 includes two clamp arms 806 and 810 that extend outward from a hollow square-shaped section 802 that receives the leg. As shown in the example of FIG. 8A, each clamp arm 806 and 810 includes an opening 818a and 818b, respectively, for receiving a screw that secures an object, such as a flag pole or a bracket, to the clamp 800. Each opening 818a and 818b may be circular, oval-shaped, hex-shaped, or another shape for receiving a screw, a bolt, a fastener, a nut, or another mechanism for securing an object between the arms 806 and 810. For example, a first opening 818a may be an oval recess that transitions into a circular opening that extends through to the interior wall of the first clamp arm 806. A nut or fastener may be positioned in the oval recess in the oval recess to secure a screw placed through the first and second openings 818a and 818b. As shown in the example of FIG. 8A, an inner portion of a second opening 818b, located on an inner wall of the second clamp arm 810, may be circular. As shown in the example of FIG. 8E, an outer portion of the second opening 818b may be hexed shaped to receive a fastener or nut. Additionally, a circular opening may be defined within the hex shape of the second opening 818b, and the circular opening may extend to an interior wall of the second clamp arm 810. In some examples, the first clamp arm 806 may be pivotally connected to an L-shaped body 812 at the pivot point 814. A portion of the L-shaped body 812 forms the second clamp arm 810. In such examples, the first clamp arm 806 may pivot outward, such that the clamp 800 may be secured to the leg. The first clamp arm 806 may then pivot inward and return to the position shown in FIGS. 8A, 8B, 8C, 8D, 8E, and 8F.

As shown in the examples of FIGS. 8E and 8F, in some examples, a padding 816 (e.g., rubber insert) is attached to one or more inner sides of the clamp 800 to help maintain the clamp in place. More specifically, respective padding 816 may be attached to one or more interior walls within the hollow square-shaped section 802. As discussed, the padding 816 may produce friction against the leg, thereby improving the stability of the clamp 800. That is, the padding 816 prevent the clamp 800 from slipping down the leg, thereby allowing the clamp 800 to bear more weight in comparison to a conventional clamp, such as the clamp 200 described with reference to FIG. 2. Each padding 816 may also be referred to as a rubber insert. The padding 816 are not limited to being rubber, other types of material may be used. The inner wall that houses the rubber insert may be indented (not shown in FIGS. 8A, 8B, 8C, 8D, 8E, and 8F. The padding 816 is not limited to being attached to the sides shown in the example of FIGS. 8E and 8F, the padding may be attached to other sides in addition to or alternate from the sides shown in the example of FIGS. 8E and 8F. Additionally, the amount of padding 816 is not limited to the padding shown in the example of FIGS. 8E and 8F, so fewer or additional padding may be used.

FIGS. 8G, 8H, 8I, 8J, 8K, and 8L are diagrams illustrating examples of different views of a clamp 825, in accordance with various aspects of the present disclosure. The clamp 825 is an example of a square-shaped clamp that is configured to couple to a square-shaped leg, such as the leg 522 described with reference to FIG. 5. Various elements of the clamp 825 are similar to the clamp 800 described with reference to FIGS. 8A, 8B, 8C, 8D, 8E, and 8F, and vice versa. For brevity, a description of the similar elements is omitted from the discussion of FIGS. 8G, 8H, 8I, 8J, 8K, and 8L.

As shown, the clamp 825 includes a hollow square-shaped section 802 at its center, which is designed to receive a square-shaped leg. This hollow section provides a secure interface for attaching the clamp to the shelter's structural elements. The third clamp arm 822 and fourth clamp arm 824 extend outwardly, parallel to each other, in opposite directions from the hollow section 802, creating a U-shaped opening on one side of the clamp. Each of the third clamp arm 822 and fourth clamp arm 824 features openings 820b and 820a, respectively, at respective distal ends, for receiving a screw, nut, or other fastener to secure an object between the third and fourth clamp arms 822 and 824. Each opening 820b and 820a may be circular, oval-shaped, hex-shaped, or another shape for receiving a screw, a bolt, a fastener, a nut, or another mechanism for securing an object between the third and fourth clamp arms 822 and 824. For example, the fourth opening 820a may be circular in both the inner wall, located on the interior of the fourth clamp arm 824, and the outer wall (e.g., exterior) of the fourth clamp arm 824. The fourth opening 820a may be formed on a circular protrusion extending from the fourth clamp arm 824. In contrast, the other openings 818a, 818b, and 820b may be formed on combined protrusions, each consisting of a circular base with a rectangular extension that runs along the respective clamp arms 810, 806, and 822. As shown in the example of FIG. 8G, an inner portion of a third opening 820b, located on an inner wall of the third clamp arm 822, may be circular. As shown in the example of FIG. 8J, an outer portion of the third opening 820b may be hexed shaped to receive a fastener or nut. Additionally, a circular opening may be defined within the hex shape of the third opening 820b, and the circular opening may extend to an interior wall of the third arm 822. These structural features of the inner and outer walls, including the various shapes and protrusions, ensure that the clamp 825 provides both a secure fit for fasteners and enhanced stability when securing objects. Together, the combination of circular and hexagonal features and the integration of protrusions enhances the functionality and reliability of the clamp 825 in diverse applications.

In addition to the third and fourth clamp arms 822 and 824, the clamp also includes first clamp arm 806 and second clamp arm 810, which extend in opposite directions from the third and fourth clamp arms 822 and 824. These first clamp arm 806 and the second clamp arm 810 mirror the functionality of the third and fourth clamp arms 822 and 824, providing additional surfaces for securing objects or structural components.

The distal ends of the clamp arms 822 and 824 are connected to the exterior walls of the hollow section 802, enhancing structural stability and rigidity. The interior walls of the clamp arms may include indentations or grooves (not explicitly shown in FIGS. 8G, 8H, 8I, 8J, 8K, and 8L for holding inserts or padding to increase friction and prevent slipping when the clamp is mounted. A pivot point 814 is located near the junction of the first clamp arm 806 and the hollow section 802. This feature allows a portion of the clamp to open, facilitating easy installation around a leg or other structural element before being locked in place. The combined features of the clamp 825 allow it to provide versatile and secure attachment points for various accessories or structural extensions.

As shown in the examples of FIGS. 8K and 8L, in some examples, one or more padding 816 (e.g., rubber inserts) may be attached to one or more inner walls of the hollow section 802 of the clamp 825 to help maintain the clamp in place. These rubber inserts may improve the stability of the clamp 825 by providing a frictional surface to help maintain it securely in place during use. The inner wall surfaces that accommodate the rubber inserts may include indentations or recessed sections (not illustrated in FIGS. 8K and 8L) to ensure proper alignment and secure attachment of the inserts. The inner walls of the clamp 825 are the surfaces that define the boundary of the hollow section 802. This hollow section 802 is the central cavity or channel designed to accommodate an object or structure that the clamp is intended to secure.

The configuration of the paddings 816 is not restricted to the specific sides shown in FIGS. 8K and 8L. These inserts can be affixed to additional or alternative inner wall surfaces of the hollow section 802, depending on the application requirements and the specific dimensions of the clamp. The material and positioning of the rubber inserts may also be tailored to optimize the clamp's performance under varying load or environmental conditions, ensuring both durability and effective grip.

FIGS. 8M, 8N, 8O, 8P, 8Q, and 8R, are diagrams illustrating examples of different views of a clamp 850, in accordance with various aspects of the present disclosure. The clamp 850 is an example of a square-shaped clamp that is coupled to a square-shaped leg, such as the leg 522 described with reference to FIG. 5. Various elements of the clamp 850 are similar to the clamp 800 described with reference to FIGS. 8A, 8B, 8C, 8D, 8E, and 8F, and the clamp 825 described with reference to FIGS. 8G, 8H, 8I, 8J, 8K, and 8L, and vice versa, for brevity, a description of the similar elements is omitted, and the focus is placed on the distinctive aspects of the clamp 850.

As shown in the example of FIGS. 8M, 8N, 8O, 8P, 8Q, and 8R, the clamp 850 includes a third clamp arm 852 and a fourth clamp arm 854, which extend outwardly and perpendicular to respective first and second clamp arms 806 and 810. Each of the third and fourth clamp arms 852 and 854 includes an opening 856a and 856b, respectively, positioned at the distal ends of the third and fourth clamp arms 852 and 854. These openings 856a and 856b are designed to receive a screw, bolt, or other fastening mechanism, allowing for the secure attachment of an object between the third and fourth clamp arms.

The third opening 856a on the third clamp arm 852 features an outer wall that defines a hexagonal recess capable of receiving a hex nut. This hexagonal recess prevents rotation of the nut during fastening, thereby facilitating the secure attachment of the screw. Additionally, the hexagonal recess transitions into a circular opening that extends through to the interior wall of the third clamp arm 852. This dual-geometry opening ensures compatibility with a range of fastening systems while maintaining a high degree of structural stability. The fourth opening 856b may be circular at both an exterior and interior wall of the fourth clamp arm 854. The fourth opening 856b extends through the fourth clamp arm 854.

The perpendicular orientation of the third clamp arm 852 relative to the second clamp arm 810 and the fourth clamp arm 854 relative to the first clamp arm 806 forms a U-shaped structure. This arrangement enhances the clamp's ability to distribute forces evenly to an object placed between the third and fourth clamp arms 852 and 854, while the clamp 850 maintains a secure grip on the attached leg or object. Together, these features ensure that the clamp 850 can reliably function in a variety of structural applications, including securing the leg of a shelter or similar assembly.

In some examples, padding (e.g., rubber inserts) is attached to one or more inner sides of the clamp 850 to help maintain the clamp in place. The inner side that houses the padding may be indented (not shown in FIG. 8C). The padding is not limited to being attached to the sides shown in the example of FIG. 8C, the padding may be attached to other sides in addition to or alternate from the sides shown in the example of FIG. 8C.

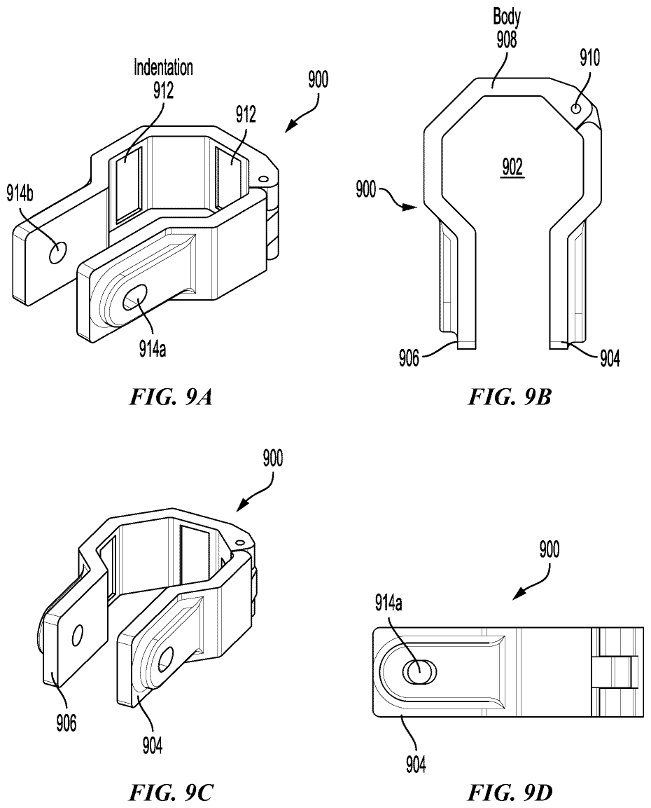

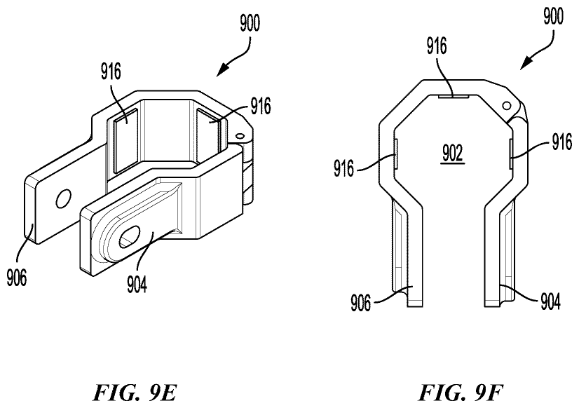

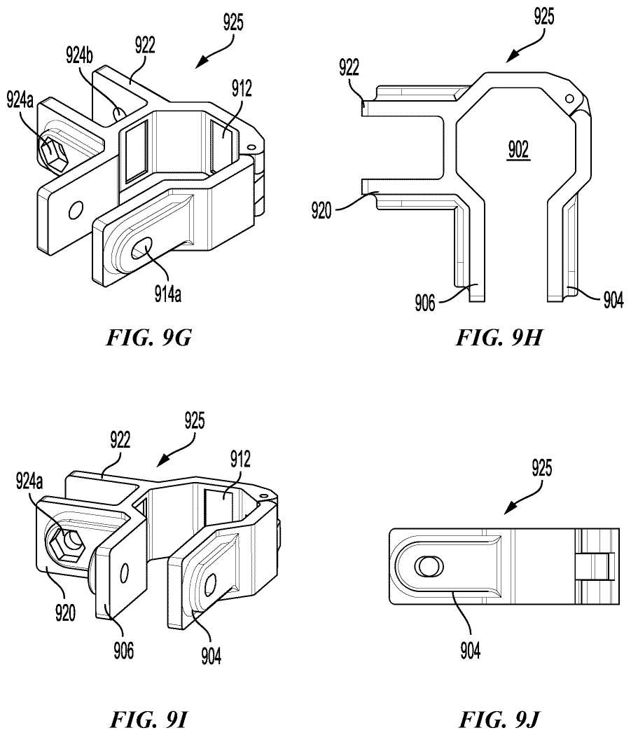

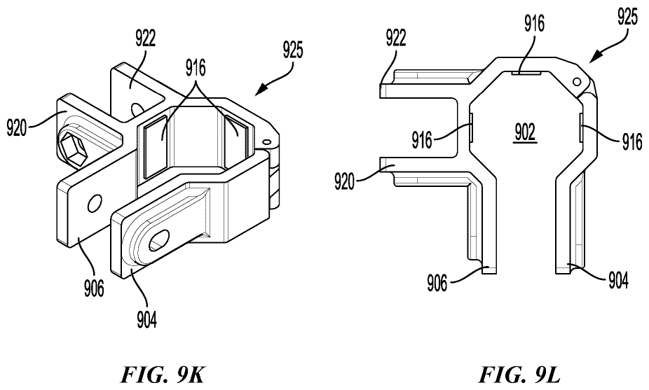

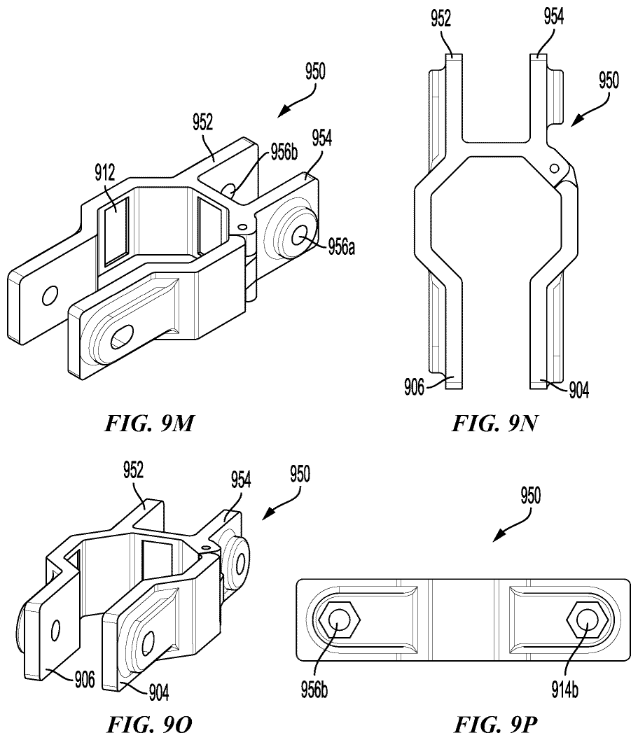

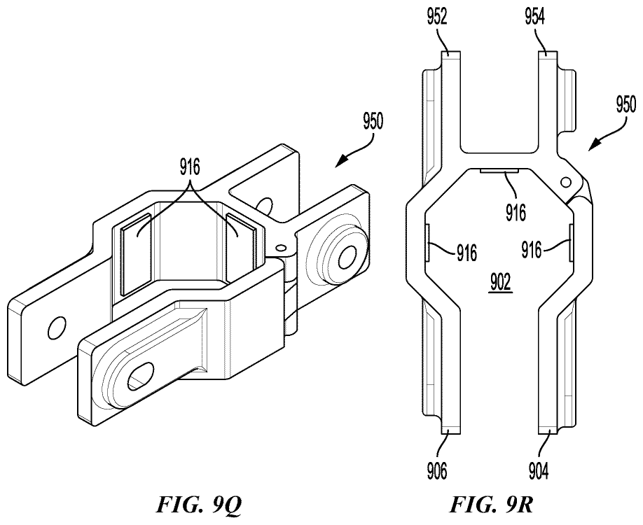

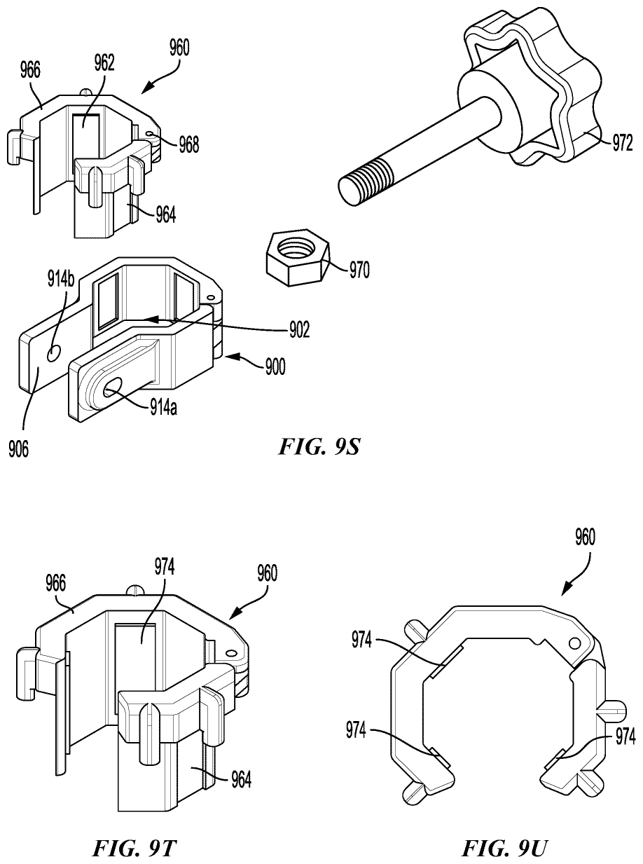

FIGS. 9A, 9B, 9C, 9D, 9E, and 9F illustrate examples of different views of a clamp 900, in accordance with various aspects of the present disclosure. In the example of FIGS. 9A, 9B, 9C, 9D, 9E, and 9F, the clamp 900 is an example of an octagon-shaped clamp for coupling to an octagon-shaped leg, such as the leg 402 described with reference to FIGS. 4A and 4B. Various elements of the clamp 900 are similar to the clamp 800 described with reference to FIGS. 8A through 8R, and vice versa. For brevity, a description of some similar elements is omitted from the discussion of FIGS. 9A through 9F.

As shown, the clamp 900 includes a hollow octagon-shaped section 902 for receiving an octagon-shaped leg. This hollow section 902 provides a secure interface for attaching the clamp to the shelter's structural elements. The hollow section 902 may be at a distal end of each clam arm 904 and 906. The clamp 900 includes a first clamp arm 904 and a second clamp arm 906, which extend outwardly from the hollow section 902. Each clamp arm 904 and 906 features openings 914a and 914b, respectively, at their distal ends, for receiving screws, nuts, or other fasteners to secure an object between the clamp arms 904 and 906. A first opening may 914a may be an oval recess that transitions into a circular opening that extends through to the interior wall of the first clamp arm 906. A nut or other fastener may be placed in the oval recess to secure a screw placed through the first and second openings 914a and 914b. These openings may be circular, oval-shaped, hex-shaped, or another configuration for receiving various fastening mechanisms. For example, the opening 914a on the first clamp arm 904 may feature a circular inner wall and a hex-shaped outer wall for receiving a nut, thereby ensuring a secure fit.

A pivot mechanism 910 in the clamp 900 serves as a hinge mechanism located near the junction of the first clamp arm 904 and the main body 908. The pivot mechanism 910 enables the first clamp arm 904 to pivot outward from the main body 908 of the clamp 900. The main body 908, which is formed integrally with the second clamp arm 906, constitutes the majority of the outer perimeter of the hollow octagon-shaped section 902. The first clamp arm 904 forms the remaining portion of the outer perimeter of the hollow section 902. This outward pivoting motion facilitates the easy installation of the clamp around a structural element, such as a leg or other supporting framework. Once positioned, the pivoting arm 904 returns to its original position, securely enclosing the leg within the hollow section 902 and ensuring a stable connection. The pivot mechanism 910 improves the usability of the clamp 900 by enabling quick and straightforward attachment without requiring significant force or tools. The pivot mechanism 910 may also improve the versatility of the clamp 900, making it suitable for diverse applications where it may be desirable to accommodate structural elements of varying shapes and sizes.

The pivot mechanism 910 may comprise a durable cylindrical hinge pin that passes through aligned holes in the first clamp arm 904 and the main body 908 of the clamp 900. In some examples, to improve usability, the pivot mechanism 910 may include a spring-loaded component that facilitates the automatic return of the first clamp arm 904 to its original position after installation, ensuring the clamp securely encloses the leg within the hollow section 902 and provides a stable connection. Additionally, the pivot mechanism 910 may incorporate a stop feature to limit the range of motion, preventing over-extension of the first clamp arm 904 and ensuring consistent alignment during repeated use. The pivot mechanism 910 is not limited to a hinge pin, other pivoting mechanisms are contemplated.

As shown in FIGS. 9E and 9F, padding inserts 916 (e.g., padding) may be attached to one or more inner walls of the hollow section 902 to increase friction between the clamp 900 and a structural element, such as a leg. These padding inserts 916 help maintain the clamp 900 in place, preventing it from slipping during use and allowing it to bear additional weight compared to conventional clamps. The padding inserts 916 may also be referred to as padding or rubber inserts (hereinafter used interchangeably). The inner walls that house the padding inserts 916 may include indentations or grooves (not explicitly shown in FIGS. 9A through 9F) to provide a housing for securely attaching the padding. The padding may be made from rubber or other friction-enhancing materials and are not limited to the specific locations shown; they may be positioned on additional or alternate inner walls as needed.

FIGS. 9G, 9H, 9I, 9J, 9K, and 9L illustrate various views of a configuration of a clamp 925, in accordance with various aspects of the present disclosure. Various elements of clamp 925 are similar to those described in clamp 900, with reference to FIGS. 9A through 9F, and vice versa. For brevity, a description of some similar elements is omitted from the discussion of FIGS. 9G. In the examples of FIGS. 9G, 9H, 9I, 9J, 9K, and 9L, the clamp 925 includes third and fourth clamp arms 920 and 922, which extend perpendicular to the first and second clamp arms 904 and 906. The third and fourth clamp arms 920 and 922 include openings 924a and 924b at their distal ends for receiving screws, nuts, or other fastening mechanisms. These openings are configured to secure objects such as brackets, poles, or other structural elements. The opening 924a on the third clamp arm 920 may include a circular inner wall and a hex-shaped recess at an outer wall that transitions to a circular opening that goes through to an inner wall of the third clamp arm 920. The opening 924b on the fourth clamp arm 922 may feature a circular opening that creates an opening between an inner wall and the outer wall of the fourth clamp arm 922. The opening 924a may be used to house a nut or fastener that passes through the corresponding opening 924b. These structural features provide compatibility with various fastening systems and enhance the clamp's versatility. The clamp 925 is equipped with a pivot mechanism 910.

As shown in FIGS. 9G, 9H, and 9I, a main body 927 is formed integrally with the second clamp arm 906, the third clamp arm 920, and the fourth clamp arm 922. The main body 927 constitutes the majority of the outer perimeter of the hollow octagon-shaped section 902. The first clamp arm 904 forms the remaining portion of the outer perimeter of the hollow section 902.

As shown in FIGS. 9G and 9I, the inner walls that house the padding inserts 916 (shown in FIGS. 9K and 9L) may include indentations 912, which are recessed areas or grooves designed to house the padding inserts 916 securely in place. Depending on the application requirements, these indentations may vary in depth and width to accommodate different insert materials or configurations. The padding inserts 916 themselves may be made from rubber or other friction-enhancing materials and are not limited to the specific locations shown, the padding inserts 916 may be positioned on additional or alternate inner walls as needed.

FIGS. 9M, 9N, 9O, 9P, 9Q, and 9R illustrate various views of a clamp 950, in accordance with various aspects of the present disclosure. In the examples of FIGS. 9M, 9N, 9O, 9P, 9Q, and 9R, the clamp 950 includes a third arm 952 and a fourth clamp arm 954, which extend outwardly in opposite directions from the first and second clamp arms 906 and 905. These arms 904, 906, 952, and 954 may be used for securing objects or structural components. Each of the third arm 952 and the fourth arm 954 features openings 956a and 956b, respectively, at their distal ends. These openings 956a and 956b are configured to receive screws, bolts, or other fasteners, allowing for the secure attachment of accessories such as brackets, poles, or swivel mounts. The openings 956a and 956b may include dual geometries, such as a circular opening at an inner wall and a hex-shaped recess at an outer wall, ensuring compatibility with various fastening systems. For example, one opening 956b may have a hex-shaped recess at an outer wall that transitions to a circular opening that goes through to an inner wall of the third arm 952. A nut or fastener in the hex-shaped recess of the opening 956b may secure a screw that is placed through a corresponding opening 956a.

As shown in FIGS. 9M, 9N, and 9O, a main body 958 is formed integrally with the second clamp arm 906, the third clamp arm 952, and the fourth clamp arm 954. The main body 958 constitutes the majority of the outer perimeter of the hollow octagon-shaped section 902. The first clamp arm 904 forms the remaining portion of the outer perimeter of the hollow section 902.

As shown in FIGS. 9M and 9O, inner walls that house the padding inserts 916 (shown in FIGS. 9Q and 9R) may include indentations 912, which are recessed areas or grooves designed to house the padding 916 securely in place. Depending on the application requirements, these indentations may vary in depth and width to accommodate different insert materials or configurations. The padding 916 themselves may be made from rubber or other friction-enhancing materials and are not limited to the specific locations shown, the padding 916 may be positioned on additional or alternate inner walls as needed.

As discussed, a clamp, such as the clamps 800, 825, 850, 900, 925, and 950, as described with reference to FIGS. 8A through 8R, as well as FIGS. 9A through 9R, may be coupled to a portion of a leg, such as an upper hollow portion of the leg. In some cases, a leg of a shelter may include an upper portion (e.g., hollow portion) and a telescoping portion (e.g., an inner portion). For example, as shown in the example of FIG. 5, the leg 508 includes a hollow upper section 522 and a telescoping lower section 520 slidably disposed within the hollow upper section 522. The telescoping lower section may have a smaller perimeter in comparison to the hollow upper section. Therefore, the clamp may not fit around the telescoping lower section. Thus, in some examples, an insert may be used to fit the clamp around the telescoping lower section.

FIGS. 9S, 9T, and 9U are diagrams illustrating different views of an insert 960 for a clamp 900, in accordance with various aspects of the present disclosure. The insert 960 may improve the adaptability and functionality of the clamp 900 by providing a secure interface with telescoping or variably sized legs. As shown in the example of FIG. 9S, the insert 960 has an octagon-shaped outer profile that is dimensioned to be slidably inserted into the hollow octagon-shaped section 902 of the clamp 900. This design allows for seamless integration with the clamp, ensuring a snug and stable fit. The insert 960 includes one or more indentations 962 positioned on its inner walls to securely house padding 974. These indentations 962 are recessed areas that not only hold the padding in place but also ensure proper alignment during assembly. The padding 974, illustrated in FIGS. 9T and 9U, is designed to improve friction between the insert 960 and the telescoping lower portion of a leg, preventing slippage and improving overall stability.

As shown in FIGS. 9S, 9T, and 9U, the insert may include a main body 966 that is pivotally connected to a second body 964 via a pivoting mechanism 968. The pivoting mechanism 968 may be similar to the pivoting mechanism 910 described with reference to FIGS. 9A through 9R. The main body 966 constitutes the majority of the outer perimeter of the insert 960. The second body 964 forms the remaining portion of the outer perimeter of the insert 960.

The padding 974 is not limited to the specific sides depicted in FIGS. 9T and 9U. It may be attached to additional or alternative inner wall surfaces, depending on the application requirements. This flexibility provides compatibility with legs of varying shapes and sizes. The material for the padding 974 may include rubber or other high-friction materials that enhance grip and durability.

In addition to the insert and padding features, FIG. 9S illustrates an example of a screw 972 that may be inserted into one or more openings of the clamp arms, such as openings 914a and 914b of the first and second clamp arms 904 and 906, respectively. The screw 972 is designed with a knob at its proximal end, facilitating manual operation and easy adjustment without the need for additional tools. The distal end of the screw 972 is threaded to securely engage a nut 970, which is seated within a hexagonal recess incorporated into one of the clamp arms. This arrangement ensures a secure connection that resists loosening during operation.

The design of the insert 960 and its associated components is not limited to octagon-shaped profiles or recesses. Other configurations, such as oval-shaped recesses and nuts, are contemplated to accommodate a broader range of structural elements. Aspects of the present disclosure are not limited to octagon-shaped inserts 960; other shaped inserts are contemplated. For example, square-shaped inserts may be used for a square-shaped clamp, such as the clamps 800, 825, and 850 described with reference to FIGS. 8A through 8R.

As discussed, an object may be held between two clamp arms of a clamp. In some examples, a bracket may be secured between the two clamp arms, serving as an intermediary mounting platform for attaching various devices. Such devices may include a pivot arm for mounting a television or fan, a flag pole, or other equipment. The bracket may fit securely against a leg or structural element of the shelter to provide stability and versatility.

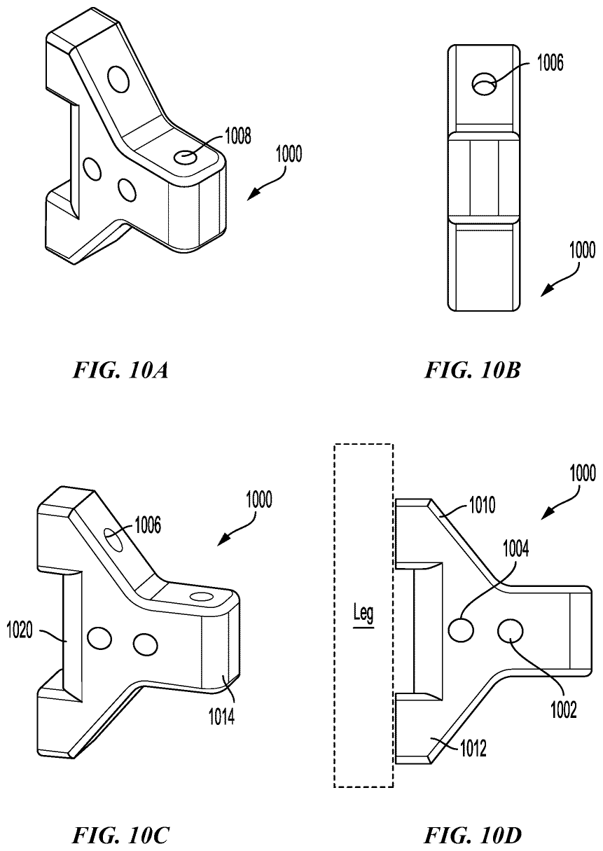

FIGS. 10A, 10B, 10C, and 10D illustrate examples of different views of a bracket 1000, in accordance with various aspects of the present disclosure. The bracket 1000 comprises three primary components: an upper arm 1010, a lower arm 1012, and a horizontal arm 1014 that connects the upper and lower arms 1010 and 1012. These components work together to form a stable and adaptable platform for securing accessories. The horizontal arm 1014 includes a first opening 1002 and a second opening 1004. These openings extend entirely through the horizontal arm 1014 from one side to the other, allowing screws or other fasteners to pass completely through. For example, a screw may pass through openings in a clamp arm, such as openings 818a and 818b in clamp 800 or openings 914a and 914b in clamp 900, and align with one of the openings 1002 or 1004, depending on the position of the clamp relative to the bracket 1000. This enables the bracket 1000 to be securely held between the clamp arms of a clamp, such as the clamp 800 described with reference to FIGS. 8A, 8B, 8C, 8D, 8E, and 8F. The horizontal arm 1014 may slide into position between the clamp arms. The openings 1002 and 1004 may be circular, oval, or hexagonal, depending on the type of fastener used.

Additionally, the horizontal arm 1014 includes a vertically defined third hole 1008, which extends completely through the horizontal arm 1014 from the top to the bottom surface. This third hole 1008 may accommodate a pivoting arm or similar structure for mounting a fan, TV, or other device. The vertical alignment of the hole ensures that attached devices remain properly oriented and stable during use. A thickness of the horizontal arm 1014 and material composition may be specified to withstand the load exerted by the mounted devices.

The upper arm 1010 of the bracket 1000 is configured to include an upper receptacle 1006, which is oriented at an upward-facing angle relative to the horizontal arm 1014. In some examples, the receptacle 1006 extends entirely through the upper arm 1010, while in other examples, it may not extend completely through the arm, forming a partial receptacle to better secure a pole or similar attachment. This receptacle 1006 is specified to receive a pole or similar attachment, such as a flag pole or decorative element. The upward angle ensures that the attached pole remains securely aligned and is less prone to tilting or displacement. The angled design of the upper arm 1010 improves the bracket's versatility, enabling it to support a variety of mounted structures.

The lower arm 1012 of the bracket 1000 works in conjunction with the upper arm to stabilize the bracket against the leg of the shelter. When used with clamps such as a clamp 800 described with reference to FIGS. 8A through 8F or a clamp 900 described with reference to FIGS. 9A through 9F, the bracket's upper and lower arms 1010 and 1012 align snugly against the leg or similar structural element, providing additional stability. Both the upper and lower arms 1010 and 1012 may include textured or recessed surfaces that improve friction and prevent slippage when the bracket is under load. Additionally, the space between the upper and lower arms 1010 and 1012 may be indented or recessed to allow the bracket to fit snugly around the leg, enhancing stability and ensuring consistent alignment. That is, the bracket 1000 further includes a notch 1020 (e.g., indentation) positioned along the horizontal arm or at the junction of the horizontal arm and upper or lower arms 1010 and 1012. The notch 1020 provides additional alignment or engagement features for secure attachment. For instance, the notch 1020 may interface with corresponding projections on the clamp arms to prevent lateral movement of the bracket 1000 during use. The notch 1020 also allows for a clamp to be secured around a majority of the leg. That is, the notch 1020 creates a gap so that a portion of the clamp can wrap around the leg. The notch also facilitates easy positioning of the bracket during installation by guiding it into place relative to the clamp and shelter leg.

The bracket 1000 may be constructed from durable materials, such as reinforced plastics or metal alloys, to ensure it can withstand repeated use and significant loads. The specific design of the bracket 1000, including the angles, dimensions, and placement of the openings, is intended to provide a robust and adaptable solution for attaching accessories to portable shelters.

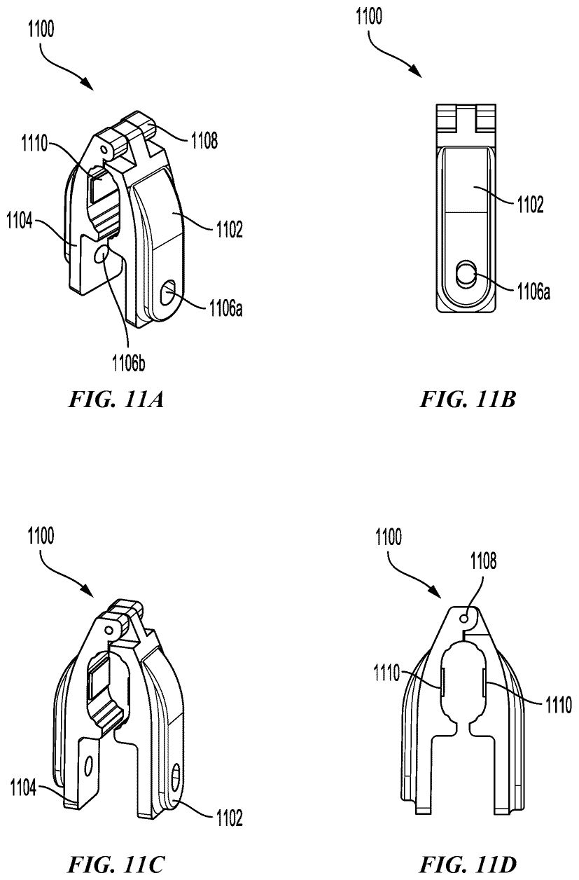

Various aspects have been described with respect to square-shaped and octagon-shaped clamps. However, such aspects are not limited to these shapes; other geometries may be utilized to match the structural elements of a shelter, including truss-links or other components. FIGS. 11A, 11B, 11C, and 11D illustrate an example of a truss-link clamp 1100, in accordance with various aspects of the present disclosure. This clamp 1100 is designed to securely attach to truss-links or similar elongated structural elements, enhancing the versatility and functionality of the overall shelter system.

The truss-link clamp 1100 features two opposing arms 1102 and 1104, which are pivotally connected at a central pivot mechanism 1108. The overall shape of the clamp 1100 resembles a capital “A,” with the two arms forming the legs of the “A” and converging at the pivot mechanism 1108. The arms are arcuate (curved) in shape, allowing them to conform to the cylindrical or tubular surfaces of typical truss-links. This pivot mechanism 1108 enables the arms 1102 and 1104 to rotate outward, functioning as a hinge to allow the clamp 1100 to open and accommodate a truss-link during installation. This mechanism consists of a central pin or axle that connects the two arms, providing a smooth axis of rotation. The pivot mechanism 1108 may include bushings or washers to reduce friction during movement and ensure durability under repeated use. When the arms are rotated outward, the truss-link can be positioned within the clamp. Once in place, the arms 1102 and 1104 are rotated inward, leveraging the pivot mechanism to securely enclose the truss-link and maintain a stable connection. Once positioned around the truss-link, the arms 1102 and 1104 move inward to securely enclose it, ensuring a stable connection. The pivot mechanism 1108 is designed to provide smooth rotational movement and is reinforced to withstand repeated usage and the loads exerted by the clamped truss-link.

To improve grip and prevent slippage, the inner surfaces of the arms 1102 and 1104 include one or more padding inserts 1108. Additionally, portions of the inner wall of each arm 1102 and 1104 may be ribbed to provide further grip, increasing friction and stability when clamping onto the truss-link. These inserts are positioned within indented portions of the inner walls, ensuring proper alignment and secure attachment. The padding inserts 1110 create friction between the clamp 1100 and the truss-link, which not only stabilizes the connection but also increases the clamp's load-bearing capacity. The material of the inserts may include high-friction rubber or other durable materials capable of withstanding environmental factors such as moisture, heat, and wear.

Each arm 1102 and 1104 of the truss-link clamp 1100 includes an opening 1106a and 1106b, respectively, through which a screw 1112 can pass. The screw 1112 is threaded to engage with a nut, such as a hex-nut, positioned within a recessed portion of one of the arms 1102 or 1104. This configuration secures the screw 1112 and prevents loosening during use. The nut may be seated in a hexagonal recess, which prevents it from rotating and facilitates straightforward tightening of the screw. The screw 1112 may also feature a knob at its proximal end to allow for manual tightening without the need for additional tools, improving ease of installation.

The arms 1102 and 1104 of the clamp 1100 are designed with structural reinforcement to handle the forces exerted during use. For instance, the pivot mechanism 1108 may be thickened or constructed from high-strength materials to resist deformation under load. The outer edges of the arms may also include ridges or texturing to improve grip during manual operation and alignment of the clamp 1100.

The truss-link clamp 1100 may be constructed from durable materials, such as reinforced polymers, metal alloys, or composites, ensuring it can endure various environmental conditions and repeated mechanical stresses. Additionally, the clamp's design accommodates truss-links of varying sizes, making it adaptable to a wide range of shelter configurations and applications. The functionality of the truss-link clamp 1100 extends beyond attachment to truss-links; it may also be used in other structural settings requiring secure, high-friction connections.

As discussed, various aspects of the present disclosure are directed to a versatile and robust clamp designed for securing structural elements such as legs of portable shelters or truss-links. The clamp includes a body and a first arm pivotally attached to the body, enabling the arm to rotate outward and inward relative to the body for easy installation. A hollow section is formed between a portion of the body and the first arm, which is dimensioned to securely enclose structural elements. The hollow may have various shapes, including square, octagon, or arcuate, to accommodate different geometries of structural elements.

The clamp further includes a second arm parallel to the first arm, working in conjunction to enclose the structural element. Both arms feature openings configured to receive screws or fasteners for securing objects between the arms. Additionally, the clamp may include a third arm and a fourth arm, extending outward and parallel to each other, with configurations such as orthogonal arrangements or dual-sided structures to enhance versatility and load distribution.

A bracket may be secured between the first and second arms, comprising an upper arm with an upper hole for receiving poles or flag mounts, a lower arm, and a horizontal arm featuring multiple holes for fastening and mounting additional devices such as pivot arms for fans or televisions. This bracket adds to the clamp's adaptability, enabling it to serve a wide range of purposes.

The inner walls of the clamp body may include indentations designed to house inserts, such as rubber inserts, which enhance grip and stability. These inserts contact the structural element, creating friction to prevent slippage and improve the clamp's ability to bear loads securely. The combination of pivot functionality, customizable geometries, integrated brackets, and friction-enhancing inserts makes this clamp an innovative solution for securing structural elements in portable shelters and similar applications.

In some examples, in accordance with various aspects of the present disclosure, a clamp may be used by rotating the first arm outward around its pivot point to open the hollow section. Furthermore, a structural element, such as a leg of a portable shelter or a truss-link, may be positioned within the hollow section of the clamp, ensuring it aligns with the desired placement. Then, the first arm may be rotated inward, enclosing the structural element securely within the hollow section. Furthermore, a screw or fastener may be placed through the openings in the first and second arms to secure an object or bracket between the arms. The screw may be threaded into a nut seated in a recessed portion of one arm to prevent rotation and maintain a firm connection. If the clamp includes additional arms, another object or bracket may be secured between the other arms.

If using a bracket, the bracket may be positioned between two arms, such as the first and second arms, aligning its openings with those of the clamp arms. The screw may be inserted through an opening of the bracket to secure the bracket to the clamp. The bracket's upper hole may be used to attach a pole or flag mount. Additionally, or alternatively, the horizontal and vertical holes may be for additional devices such as pivot arms for mounting a fan or television. For improved performance, the padding in the inner walls of the clamp may be positioned to make firm contact with the structural element. The padding may improve grip and prevent slippage during use.

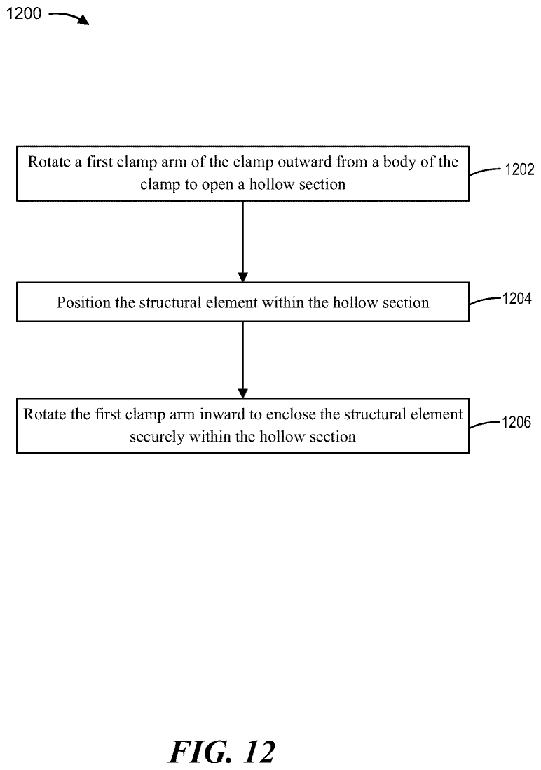

FIG. 12 is a flow diagram illustrating an example of a process 1200 for using a clamp, in accordance with various aspects of the present disclosure. The clamp may be an example of a clamp 800, 825, 850, 900, 925, 950, or 1100 as described with reference to FIGS. 8A through 8R, 9A through 9U, and 11. As shown in the example of FIG. 12, the process 1200 begins at block 1202 by rotating a first arm of the clamp outward from a body of the clamp to open a hollow section. The first arm is pivotally coupled with the body, which is integrated with a second arm that extends outward and parallel to the first arm. This creates the hollow section for receiving the structural element.

At block 1204, the process includes positioning the structural element within the hollow section. For example, the structural element may be a leg of a portable shelter or a truss-link. Padding may optionally be positioned in the inner walls of the hollow section to enhance grip and prevent slippage during use. At block 1206, the first arm is rotated inward to enclose the structural element securely within the hollow section.

At block 1208, the process 1200 includes inserting a screw or fastener through openings in the first and second arms of the clamp. These openings, located near the distal ends of the arms, align with one another. The screw is then threaded into a nut seated in a recessed portion of the one of the arms to secure the structural element and maintain a firm connection with the arms and an object placed between the arms. Additionally, or alternatively, the fastener may be placed through an object that is held between the arms. A bracket may be an example of an object that is held between the arms.

If the bracket is used, the process 1200 continues at block 1210, where a bracket is positioned between the first and second arms of the clamp. The bracket may include an upper arm, a lower arm, and a horizontal arm. At block 1212, the openings in the horizontal arm of the bracket are aligned with the openings in the first and second arms of the clamp. At block 1214, the bracket is secured by inserting the screw through the aligned openings.

In some examples, the process 1200 includes attaching a pole or flag mount to an upper receptacle in the upper arm of the bracket (block 1216). Optionally, additional devices, such as pivot arms for mounting a fan or television, may be attached to horizontal or vertical holes in the horizontal arm of the bracket. If the clamp includes additional arms extending from the body, the process 1200 may include securing another object or bracket between these additional arms. This involves inserting a screw or fastener through corresponding openings in the additional arms.

In some examples, an insert may be added within the hollow section of the clamp to further enhance the grip or to adapt the clamp to structural elements (e.g., legs) of varying sizes or shapes. The insert may be an example of an insert 960 described with reference to FIGS. 9S, 9T, and 9U. The insert can be configured to fit snugly within the hollow section and may include features such as textured surfaces or padding to improve contact with the structural element.

As used herein, a phrase referring to “at least one of” a list of items refers to any combination of those items, including single members. As an example, “at least one of: a, b, or c” is intended to cover: a, b, c, a-b, a-c, b-c, and a-b-c.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A clamp, comprising:
a body integrated with a second arm; and
a first clamp arm pivotally attached to the body, the first clamp arm configured to rotate outward and inward relative to the body, the first clamp arm being parallel with the second clamp arm, a portion of the body and a portion of the first clamp arm form a hollow section to contain a structural element.

2. The clamp of claim 1, further comprising an insert placed within the hollow section to adjust a size of the hollow section.

3. The clamp of claim 1, wherein the hollow section is square-shaped, octagon-shaped, or arcuate in accordance with a geometry of the structural element.

4. The clamp of claim 1, wherein each of the first clamp arm and the second clamp arm includes an opening for receiving a fastening device.

5. The clamp of claim 1, further comprising a third clamp arm and a fourth clamp arm, wherein the third clamp arm and the fourth clamp arm are parallel to each other and extend outward from the body.

6. The clamp of claim 5, wherein the third clamp arm is perpendicular to the second clamp arm and the fourth clamp arm is perpendicular to the first clamp arm.

7. The clamp of claim 5, wherein the third clamp arm extends in a first opposite direction from the second clamp arm, and the fourth clamp arm extends in a second opposite direction from the first arm.

8. The clamp of claim 1, wherein:
a bracket is secured between the first clamp arm and the second clamp arm; and
the bracket comprises:
an upper arm comprising an upper hole,
a lower arm, and
a horizontal arm comprising one or more horizontal holes and one or more vertical holes.

9. The clamp of claim 8, wherein a pivoting arm is secured to a vertical hole of the one or more vertical holes.

10. The clamp of claim 1, wherein:
an inner wall of the body includes one or more indentations; and
each of the one or more indentations is configured to couple to a respective padding insert of a group of padding inserts.

11. The clamp of claim 10, wherein each padding insert of the group of padding inserts is a rubber padding insert.

12. The clamp of claim 10, wherein a first side of each padding insert is attached to a respective indentation of the one or more indentations, and a second side of each padding insert is in contact with the structural element.

13. The clamp of claim 1, wherein the structural element is a leg of a portable shelter or a truss-link.

14. A method of securing a structural element using a clamp, comprising:
rotating a first clamp arm of the clamp outward from a body of the clamp to open a hollow section, the first clamp arm pivotally coupled to the body, the body integrated with a second clamp arm that extends outward from the body, the second arm being parallel to the first clamp arm;
positioning the structural element within the hollow section; and
rotating the first clamp arm inward to enclose the structural element securely within the hollow section.

15. The method of claim 14, further comprising: inserting a screw through openings in the first and second clamp arms, the openings located at respective distal ends of each of the first and second clamp arms; and threading the screw into a nut seated in a recessed portion of the second clamp arm to secure an object or a bracket between the first and second clamp arms and maintain a firm connection.

16. The method of claim 15, further comprising positioning the bracket between the first and second clamp arms, the bracket including an upper arm, a lower arm, and a horizontal arm, wherein the bracket is secured to the clamp via the inserted screw.

17. The method of claim 16, further comprising: attaching a pole or flag mount to an upper receptacle in the upper arm of the bracket; and optionally attaching additional devices, such as pivot arms for mounting a fan or television, to horizontal or vertical holes in the horizontal arm of the bracket.

18. The method of claim 14, wherein the structural element is a leg of a portable shelter or a truss-link.

19. The method of claim 14, wherein on one or more inner walls of the hollow section of the clamp include padding.

20. The method of claim 14, wherein the clamp includes third and fourth clamp arms extending orthogonally from the body, and further comprising: securing another object or bracket between the third and fourth clamp arms by inserting a screw or fastener through corresponding openings in the third and fourth clamp arms.
